(19) United States
(12) Patent Application Publication
(10) Pub. No.: US 2018/0139101 A1
(43) Pub. Date: May 17, 2018

(54) FLOW SATE TRANSFER FOR LIVE MIGRATION OF VIRTUAL MACHINE

(71) Applicant: Microsoft Technology Licensing, LLC, Redmond, WA (US)

(72) Inventors: Ranjit Puri, Bothell, WA (US); Vikas Bhardwaj, Redmond, WA (US); Madhan Sivakumar, Bothell, WA (US); Manish Tiwari, Bellevue, WA (US)

(21) Appl. No.: 15/352,497

(22) Filed: Nov. 15, 2016

(51) Int. Cl. H04L 12/24; H04L 29/12

(52) U.S. Cl. CPC H04L 41/12; H04L 67/10; H04L 61/2507

(57) ABSTRACT

Methods, systems, and devices are described herein for facilitating live migration of a virtual machine from a source host to a destination host. In one aspect, a method for facilitating live migration may include obtaining connection state information corresponding to a configured communication link of a virtual machine associated with a source host. The method may further include migrating the connection state information to a destination host selected for live migration of the virtual machine. The method may additionally include modifying the connection state information based on the destination host to generate modified connection state information. The virtual machine, after live migration to the destination host, may be configured to maintain the configured communication link using the modified connection state information.

### TECHNICAL FIELD

This disclosure relates generally to live migration of virtual machines, and more specifically to live migration of virtual machines in a software defined network.

### BACKGROUND

Virtualization of networks is common in modern datacenters for various applications. Virtualization allows datacenter tenants to create a network with an addressing scheme that is suitable for various workloads and also allows the tenant administrator to set networking policies within their network as they see fit.

These virtualized tenant networks are an overlay atop of the underlying physical network of the datacenter. The networking interfaces in a tenant virtual machine (VM) are therefore connected directly to the virtualized tenant network (or the overlay network). Switches, which are aware of both virtualized networks and the physical networks, perform appropriate transformations to ensure that packets are delivered to and from the virtualized network endpoints in a way that both the overlay endpoints and the underlay endpoints are unaware of the specifics of the network virtualization intended by the tenant administrators.

Programming of virtualization aware switches is typically done by a software defined networking (SDN) controller. An SDN controller may maintain a repository of the intended networking state in the datacenter and also incorporate logic to achieve that state, e.g. by programming switches.

Load balancing is a typical function desired in modern datacenters. Load balancers map virtualized IPs (VIP) to a set of Data Center IPs (DIPs). DIP endpoints may represent endpoints inside the virtualized network of a tenant. VIPs are typically internet or at least datacenter routable, e.g., they are not virtualized. DIPs on the other hand are typically virtualized. In order to perform the translation between non virtualized (VIP) endpoints and virtualized (DIP) endpoints, load balancers running under an SDN controller must be aware of the network virtualization policies that the SDN controller intends to achieve in the datacenter. Load balancers must also work in concert with other components in the SDN controller to achieve load balancing of workloads virtualized in the tenant space.

In a typical datacenter, hosts sometimes need to be taken out of service for example, for servicing, maintenance, upgrades to server software, etc. In such cases, tenant workloads are typically live migrated to another host so that the workloads experience minimal or no down time. In the live migration scenario, CPU context for all processes running within the migrated workload is ensured to be restored on the destination host. In a similar way, it is also beneficial to ensure that the network flows terminating at the migrating workload are restored at the destination host. This is also true for flows originating outside the datacenter such as those coming over a load balancer.

In some cases, VMs, with networking virtualized using SDN may rely on programmable switches to ensure packets in the virtual network can flow between tenant VMs and/or edge infrastructure. These switches transform the packets received from the tenant VMs and perform encapsulation as needed to ensure delivery to destination tenant VMs which may be running on other hosts. The switch on the receiving host similarly decapsulates and performs any other transformation as necessary to ensure that the packet received over the provider (data center) network is delivered to the receiving tenant VMs. In many cases, the receiving and sending tenant VMs are oblivious to the fact that their networks are virtualized and that they are really running over the data center's network.

SDN Switches employ transformation logic to achieve the translation between the virtual and provider networks. In some cases, this transformation logic may be implemented by a Virtual Filtering Platform (VFP), which may be an extension of a Server vSwitch, such as implemented by Windows. The VFP is generally programmable and is responsible for the bulk of SDN data path processing on SDN hosts. Other than transformations, virtual switches are also responsible for enforcing networking policies intended by tenant network administrators (e.g., the tenant administrator may wish that a virtual machine should never receive a TCP packet bound to port 8080). The tenant administrator can configure an ACL to express this. This ACL is eventually programmed onto VFP which ensures that any such packets received from the provider network are dropped.

When a VM is migrated, the transformation logic and other rules of a specific SDN switch may be lost, for example, due to the VM being associated with a different host and different SDN switch after migration. Accordingly, improvements can be made in techniques for improving live migration of VMs.

### SUMMARY

Illustrative examples of the disclosure include, without limitation, methods, systems, and various devices. In one aspect, methods, systems, and devices are described herein for facilitating live migration of a virtual machine from a source host to a destination host. In one aspect, a method for facilitating live migration may include obtaining connection state information corresponding to a configured communication link of a virtual machine associated with a source host. The method may further include migrating the connection state information to a destination host selected for live migration of the virtual machine. The method may additionally include modifying the connection state information based on the destination host to generate modified connection state information. The virtual machine, after live migration to the destination host, may be configured to maintain the configured communication link using the modified connection state information.

Other features of the systems and methods are described below. The features, functions, and advantages can be achieved independently in various examples or may be combined in yet other examples, further details of which can be seen with reference to the following description and drawings.

### BRIEF DESCRIPTION OF THE DRAWINGS

Embodiments of the present disclosure will be described more fully hereinafter with reference to the accompanying drawings, in which:

FIG. 1 depicts an example diagram of a client device in communication with one or more virtual resources via a load balancer.

FIG. 2 depicts an example architecture of a software load balancer in communication with multiple virtual machines.

FIG. 3 depicts an example of inbound traffic to one or more virtual machines via a load balancer.

FIG. 4 depicts another example of inbound traffic to one or more virtual machines via a load balancer.

FIG. 5 depicts an example of inbound and outbound traffic to one or more virtual machines.

FIG. 6 depicts an example of a live migration of a virtual machine from a source host to a destination host.

FIG. 7 depicts an example transformation of connection rule information from a source host to a destination host selected for live migration of a virtual machine.

FIG. 8 depicts an example process for migrating and modifying connection rule information for a live migrated virtual machine.

FIG. 9 depicts an example general purpose computing environment in which the techniques described herein may be embodied.

### DETAILED DESCRIPTION OF ILLUSTRATIVE EMBODIMENTS

Systems and techniques are described herein for migrating and modifying connection state information or flow state for a live migrated virtual machine (VM), in order to maintain previously established connections with the VM. In one aspect, a VM may be live migrated from a source host associated with a source switch or agent to a destination host associated with a destination switch or agent. Each of the source and destination switches, which may implement software defined networking (SDN), may perform network address translation (NAT) functions or transformations, and/or enforce other connection state information between the VM and other VMs or edge infrastructure, such as a load balancer or multiplexer (MUX). Upon configuration of these connections, the source switch may store or maintain the transformations and/or connections rules. When the VM is live migrated to a destination host, a new destination switch may provide NAT'ing functions for the VM. In order to ensure that previously established connections with the VM, via the source host switch, are maintained, the flow state and/or other connections rules may be transferred or migrated from the source switch to the destination switch. The flow state and/or connection state information may also be modified, for example, to replace entries or references to a provider address or physical address (PA) of the source host, to a PA of the destination host. In this way, configured or established connections with a VM may be maintained through live migration of the VM.

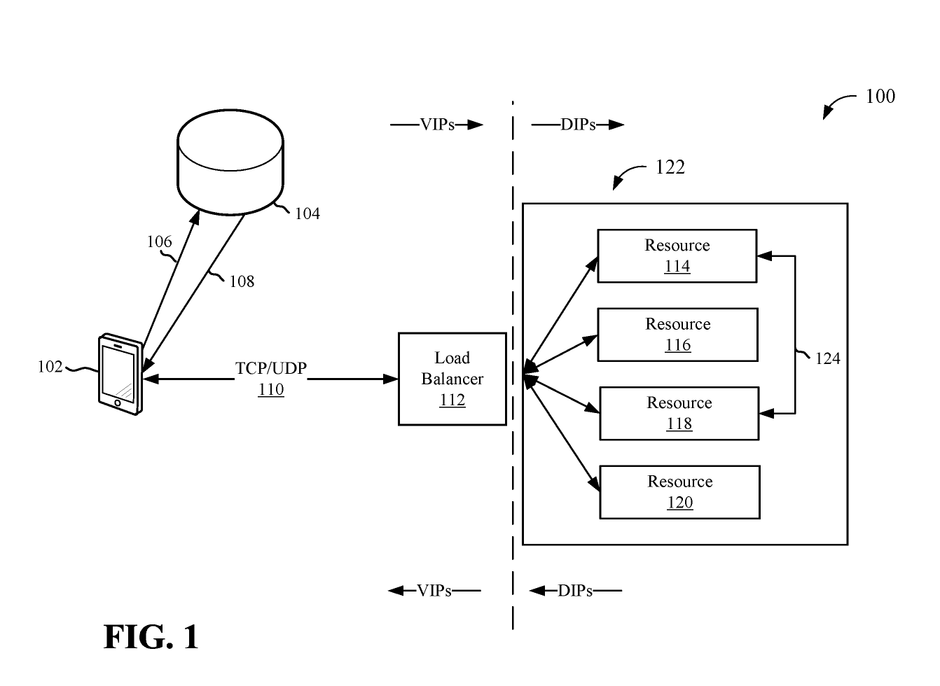

FIG. 1 illustrates an example system 100 that includes a client device 102 in communication with a datacenter or other virtual platform 122. In one example, client 102, which may be representative of any device or origin of request for virtualized services provided by datacenter 122, may have some work to be performed by datacenter 122. In one example, client device 102 may communicate with a domain name system (DNS) 104 to obtain one or more virtualized IP addresses (VIPs) of a service or other process running in the datacenter 122. Client device 102 may send a lookup request for a particular service, application, or data managed by datacenter 122 at operation 106. The DNS 104 may look up the service or data associated with the request and return at least one VIP associated with the requested data, service, etc. The client device 102 may then communicate with the datacenter 122, at operation 110. In some aspects, this may be over a TCP, UDP (e.g., over layer 4 of OSI), or other communication protocol, as is known in the art.

The datacenter may implement a load balancer 112, which may distribute incoming traffic among resources or virtual machines (VM)s, or VM instances 114-120. As used herein, a VM instance may be an instantiation of a VM executing on a host device. Multiple instances of the same VM (e.g., same configuration, data, logic, etc.), may be executed concurrently on the same or different devices or hosts. In some aspects, the load balancer 112 may include a hardware component. In other cases the load balancer 112 may be implemented in software, e.g., as a software load balancer (SLB). As described in the rest of the disclosure, only an SLB will be described in detail. However, it should be appreciated that the techniques described herein may also be easily implemented with hardware load balancers as well. The load balancer 112 may convert data (e.g., packets) addressed to a VIP to a datacenter internet protocol address (DIP), for routing to one or more resources 114-120. The load balancer 112 may also provide outbound internet connectivity via translating packets destined for external locations, such as client device 102. In some cases, the load balancer 112 may also provide intra-datacenter routing, for example between any of resources 114, 116, 118, or 120, for example represented by link 124.

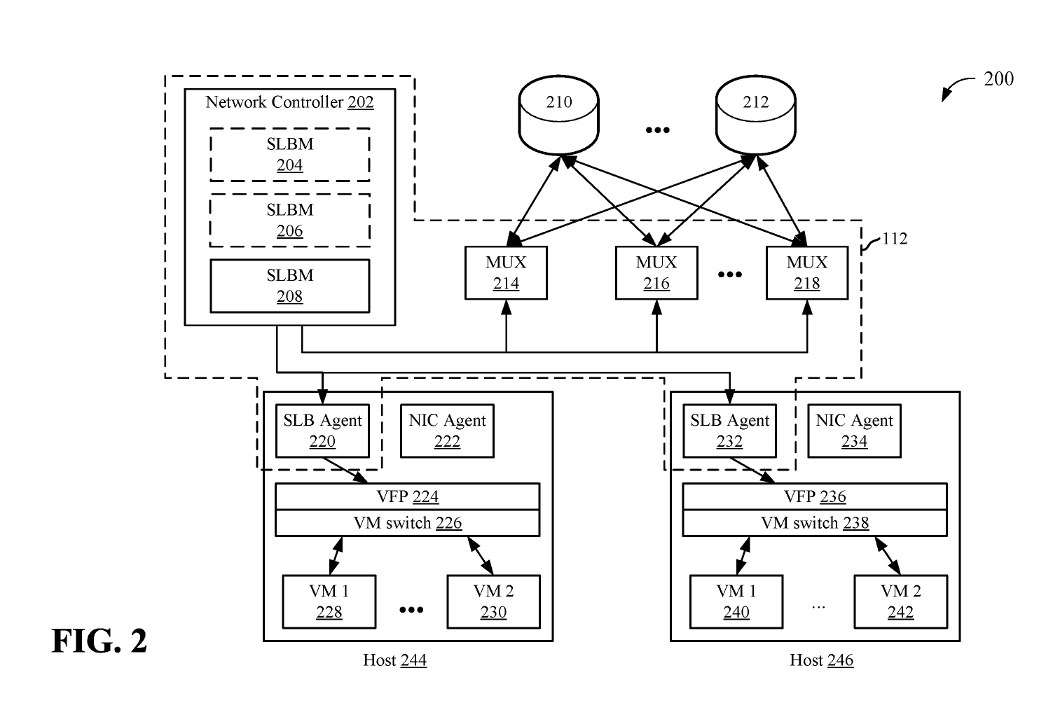

FIG. 2 illustrates an example data center 200, which may implement one or more software load balancers 112. Software load balancer (SLB) 112, as illustrated, is a distributed system that comprises multiple datacenter components that work in concert to perform load balancing and network address translation (NAT) functions.

In some aspects, load balancer 112 may include a network controller 202, which may control routing, addressing, and other aspects of datacenter 200/VMs. The network controller 202 may include one or more instances of a software load balancer manager (SLBM) 204, 206, 208. Each SLBM 204, 206, 208 may process SLB commands coming in through one or more APIs and be responsible for programming goal states. Each SLBM 204, 206, 208 may synchronize state between the different components in SLB 112. In some aspects, each SLBM 204, 206, 208 may be responsible for a certain number of VMs 228, 230, 240, 242, and/or a number of host devices 244, 246, and so on.

The network controller 202/SLBM instances 204, 206, 208 may communicate with one or more multiplexer (MUXes) 214, 216, 218. Each of MUXes 214, 218, 218 may receive traffic that is routed via routers 210, 212 using ToR or other anonymity network technique, for example that may receive traffic from one or more networks, such as the internet. In some aspects, the one or more routers 210, 212 may route inbound traffic to one or more MUXes 214, 216, 218 using equal-cost multi-path routing (ECMP). In some aspects, the one or more routers 210, 212 may communicate with MUXes 214, 216, 218 using Border Gateway Protocol (BGP). Each SLBM 204, 206, 208 may determine policies for distribution of traffic/requests to MUXes 214, 216, 218. Each SLBM 204, 206, 208, may also determine policies for routing data from MUXes 212, 214, 216 to one or more hosts 244, 246 (e.g., hyper-V enabled hosts). Each SLBM 204, 206, 208 may also manage VIP pools that map VIPs to DIPs of different VMs 228, 230, 240, 242,

Each MUX 212, 214, 216 may be responsible for handling data. Each MUX 212, 214, 216 may advertise to router 210, 212 its own IP address as the next hop for all the VIPs it is associated with. MUXes 212, 214, 216 may receive traffic from the routers 210, 212 and may performed load balancing to map the traffic to available VMs 228, 230, 240, 242.

Each host device 244, 246, which may include various types and configurations of computing devices such as servers and the like, may execute or otherwise be associated with an SLB host agent 220, 232. Each SLB host agent 220, 232 may be responsible for programming rules on the hosts 244, 246. Each SLB host agent 220, 232 may also be the requesting port for SLBM 204, 206, 208 for outbound connections. Each SLB host agent 220, 232 may send health probes to VMs 228, 230, 240, 242 (e.g., addressed to a DIP associated with each VM, where the DIP is in the tenant's virtual network space) and receive responses from the VM concerning their health, status, etc., via one or more VM switches 226, 238. Each VM switch 226, 238 may be associated with a virtual machine filtering platform (VFP) to facilitate multitenant VM implementations. In some aspects, an NIC agent 222, 234, on each host 244, 246, may facilitate creation of a virtualized NIC from which the SLB host agent 220, 232 may send probe requests.

In some aspects, each host device 244, 246 may be associated with a hypervisor. In some aspects, SLB host agents 220 and 232 may execute via the hypervisor or Hyper-V host. Each SLB host agent 220, 232 may listen for SLB policy updates from controller 202/SLBM 204, 206, 208 and program rules to a corresponding VM switch 226, 238. VM switches 226, 238 may be designed to facilitate operations in a software defined network (SDN), and process the data path for SLB de-encapsulation and NAT. Switches 226, 238 may receive inbound traffic through MUXes 214, 216, 218, and route outbound traffic either back through MUXes 214, 216, 218 or directly to outside IPs, bypassing the MUXes 214 216, 218.

In some cases, DIP endpoints may not be virtualized, such as if they are associated with VMs that contribute to a datacenter's infrastructure. These DIPS may also be behind or work in conjunction with a load balancer and/or be live migrated. As used herein, a DIP endpoint may be virtualized or non-virtualized, and the described techniques may operate on both types of DIPs.

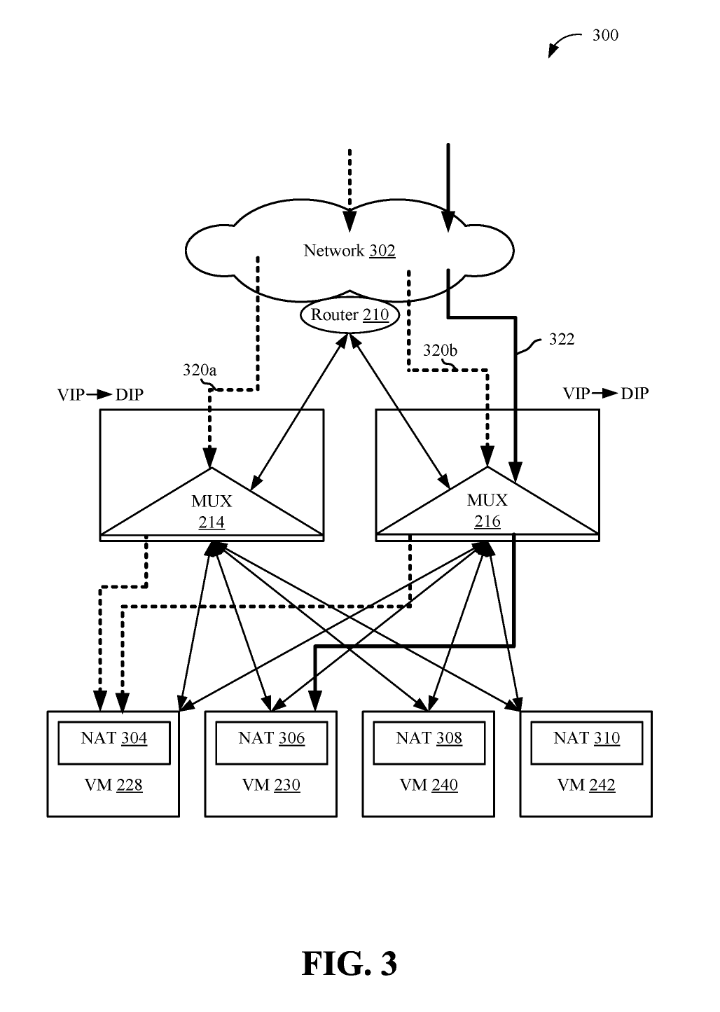

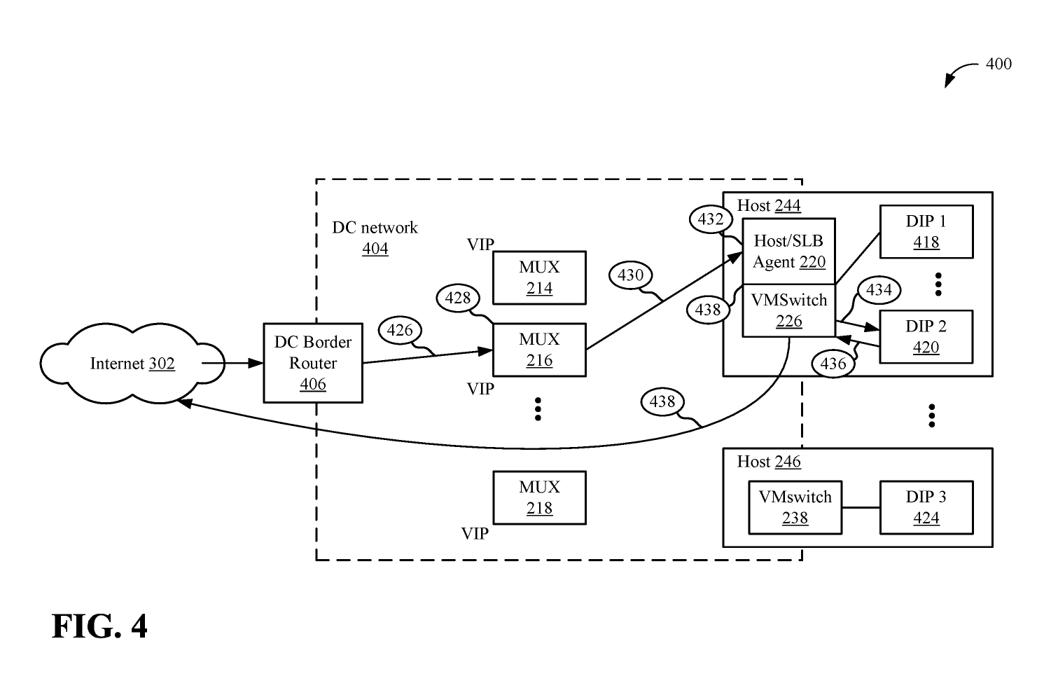

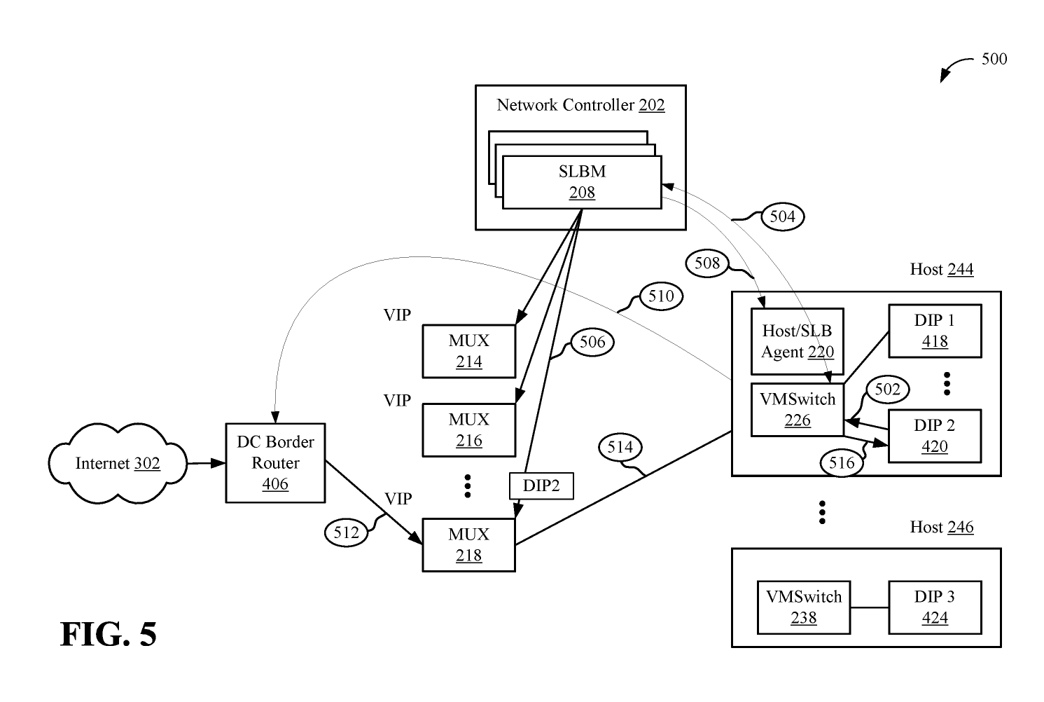

Inbound data flows will be described in reference to FIGS. 3 and 4, and outbound flows will be described in reference to FIG. 5.

FIG. 3 depicts an example process flow 300 of inbound traffic to one or more virtual machines via a load balancer. A first connection or flow may be depicted as dotted line 320. In the example system illustrated, flow 320 may take two paths to arrive at VM 228, either through MUX 214 or through MUX 216, as represented by flows 320a and 320b. A second flow 322 may be directed at VM 230, and may be routed through MUX 216.

As illustrated, the top layer or first tier may include a network 302, such as the internet, and router 210, which may be responsible for distributing packets via ECMP to MUXes 214, 216, for example, on layer 3 of the data plane. The MUXes 214 and 216 may be on the second tier, and may provide encapsulation via translating VIPs to DIPS, to route data to one or more VMs 228, 230, 240, 242, on layer 4 of the data plane. As ECMP hashing may not be inherently stable, MUXes 214 and 216 may maintain a consistent hash to ensure packets from same flow get routed to the same server or VM. MUXes 214 and 216 may encapsulate packets via Virtual Extensible LAN (VXLAN) or Network Virtualization using Generic Routing Encapsulation (NVGRE) to a VM, such a associated with a DIP.

The VMs 228, 230, 240, 242 may be on the third tier, and may each employ NAT functionality 304-310, which may de-capsulate the packets received from MUXes 214, 215 and deliver them to the corresponding VM.

FIG. 4 depicts another inbound flow of data 400 to a datacenter/VMs managed by a load balancer, such as the software load balancer described above in reference to FIG. 2. Packets destined for a VIP may be load balanced and delivered to the DIP of a VM. When a VIP is configured, each MUX 214, 216 may advertise a route to its first-hop router, e.g., a datacenter (DC) border router 406, announcing itself as the next hop for that VIP. This causes the router(s) 406 to distribute packets, received via a network or the internet 302, destined for the VIP across all the MUX nodes 214, 216 based on ECMP, as depicted by operation 426. Upon receiving a packet, the MUX 216 may select a DIP for the connection based on one or more load balancing algorithms. The MUX 216 may then encapsulate the received packet setting the selected DIP as the destination address in the outer header of the packet, at operation 428. In some cases, the MUX 216 may encapsulate the packet using IP-in-IP protocol, VXLAN, NVGRE, or other similar protocol. The MUX 216 may then send the encapsulated packet using regular IP routing at the MUX 216, at operation 430. In some cases, the MUX 216 and the DIP, here DIP2 420, do not need to be on the same VLAN, they may just have IP (layer-3) connectivity between them. The host agent or SLB agent 220, located on the same physical machine 224 as the target DIP, DIP2 420, may intercept this encapsulated packet, remove the outer header, and rewrite the destination address and port, at operation 432. In some aspects, the VFP 224, 236, which may be programmed by the SLB agent 220, 232, may intercept encapsulated packets. The SLB Agent 220 may record this NAT state. The SLB agent 220 may then send the re-written packet, via VM switch 226, to the VM associated with DIP 2 420. The SLB host agent 220 may then send the rewritten packet to the VM, at operation 434.

When the VM sends a reply packet for this connection, at operation 436, it is intercepted by the SLB agent 220. The VFP 224, 236 (programmed by the SLB Agent 220) may perform reverse NAT based on the state recorded at operation 432, and rewrite the source address and port, at operation 438. The SLB agent 220 may then send the packet out to the router 406 towards the source of the connection, at operation 438. The return packet may bypass the MUX 216, thereby saving packet processing resources and network delay. This technique of bypassing the load balancer on the return path may be referred to as Direct Server Return (DSR). In some cases, not all packets of a single connection would end up at the same MUX 216; however, all packets for a single connection must be delivered to the same DIP. Table 1 below shows an example of addressing of a packet through the flow described above. As described herein, IPs are presented for simplicity, but layer 4 translations, e.g. mapping VIP: PortA to DIP: PortB, can happen as part of load balancing and NAT.

TABLE 1

| | Outer IP | Outer IP | Original IP | Original IP |
|---|---|---|---|---|
| | Address: | Address: | Address: | Address: |
| Operation | Source | Destination | Source | Destination |
| 426 | | | Client DIP | VIP |
| 430 | MUX IP | Host | Client DIP | VIP |
| | | physical or | | |
| | | provider | | |
| | | address | | |
| 434 | | | Client DIP | DIP2 |
| 436 | | | DIP2 | Client DIP |
| 438 | | | VIP | Client DIP |

FIG. 5 depicts an example process flow 500 of outbound and inbound traffic to one or more virtual machines via a load balancer. From a high level, outbound traffic flow may be described in a few steps or operations. First, a host plugin or SLB agent 220 may first request a SNAT port from the SLBM 208. The SLBM 208 may configure a SNAT port on the MUXes 214, 216, 218 and provide the port configurator to the SLB agent 220. The SLB agent 220 may then program a NAT rule into a virtual switch/VFP to do the routing/network address translation. The outbound process flow will now be described in more detail with more specific reference to FIG. 5.

In some aspects, the SLBM 208 may enable distributed NAT for outbound connections, such that even for outbound connections that need source NAT (SNAT), outgoing packets may not need to be routed through a MUX 214, 216, 218. Process 500 illustrates an example of how packets for an outbound SNAT connection are handled. A VM associated with a DIP, such as DIP2 420, may first send a packet containing its DIP as the source address, a destination port, and an external address as the destination address, at operation 502. The VFP 224, 236 may intercept the packet and recognize that the packet needs SNAT. The host/SLB agent 220 may hold the packet in a queue and send a message to SLBM 208 requesting an externally routable VIP and a port for the connection, at operation 504. SLBM 208 may allocate a VIP and a port, from a pool of available ports and configure each MUX 214, 216, 218 with this allocation, at operation 506. The SLBM 208 may then send this allocation to the SLB agent 220, at operation 508. The SLBM 208 may use this allocation to rewrite the packet so that its source address and port now contain a VIP and the designated ports. The SLBM 208 may send the rewritten packet directly to the router 406, at operation 510. The return packets from the external destination are handled similar to inbound connections. The return packet is sent by the router 406 to one of the MUXes 214, 216, 218, at operation 512. The MUX 218 already knows that DIP2 should receive this packet (based on the mapping in operation 506), so it encapsulates the packet with DIP2 as the destination and sends the packet to host 244, at operation 514. The SLB agent 220 intercepts the return packet, performs a reverse translation so that the packet's destination address and port are now DIP2 and a destination port. The SLB host agent 220 may then send the packet to the VM associated with DIP2 420, at operation 516. Table 2 below shows an example of addressing of a packet through the flow described above.

TABLE 2

| | Outer IP | Outer IP | Original IP | Original IP | Source | Destination |
|---|---|---|---|---|---|---|
| | Address: | Address: | Address: | Address: | port | port |
| Operation | Source | Destination | Source | Destination | (TCP/UDP) | (TCP/UDP) |
| 502 | | | DIP2 | Client DIP | Dynamic | Client port |
| | | | | | port | |
| 504 | SLBM to lease VIP port | | | | VIP port | |
| 510 | | | VIP | Client DIP | VIP port | Client port |
| 512 | | | Client DIP | VIP | Client port | VIP port |
| 514 | Load | Host | Client DIP | VIP | Client port | VIP port |
| | Balanced | physical or | | | | |
| | IP | provider | | | | |
| | | address | | | | |
| 516 | | | Client DIP | DIP2 | Client port | Dynamic |
| | | | | | | port |

In some aspects, internet VIPs may be shared for outbound traffic amongst VMs in the cloud service/datacenter. One or more ports may be pre-allocated per DIP to ensure a min guaranteed outbound connections, whereas the rest of the ports may be allocated dynamically. In some cases, port allocation may be optimized to maximize concurrent connections to different destinations.

Similar to the inbound and outbound communications described above, VMs within the same datacenter or datacenter network may communicate with each other. These communications may include stateful flows or communication links (e.g., not necessarily stateful communication links or connections), for example, the parameters (e.g., transformations and/or rules) of which may be established in the first communication or communications between a VM and another VM or a load balancer/MUX (as also similar to the inbound and outbound communications described above). For example, between VMs communicating over the TCP layer (e.g., layer 4), a flow state may be created in the exchange of the SYN, SYN ACK, and ACK packets. In order to maintain communication links established with a VM, for example, when it is live migrated to a different host device, the communication link transformations, rules, and/or state, may be transferred to the destination host and modified so that any prior reference in the connection information to the source host is changed to the destination host. In one example, this may include changing the provider or physical address (PA) in the connection information from a source PA to a destination PA. Other rules or transformations may also be transferred and/or modified to maintain the previously established or configured communication links with the live migrating VM.

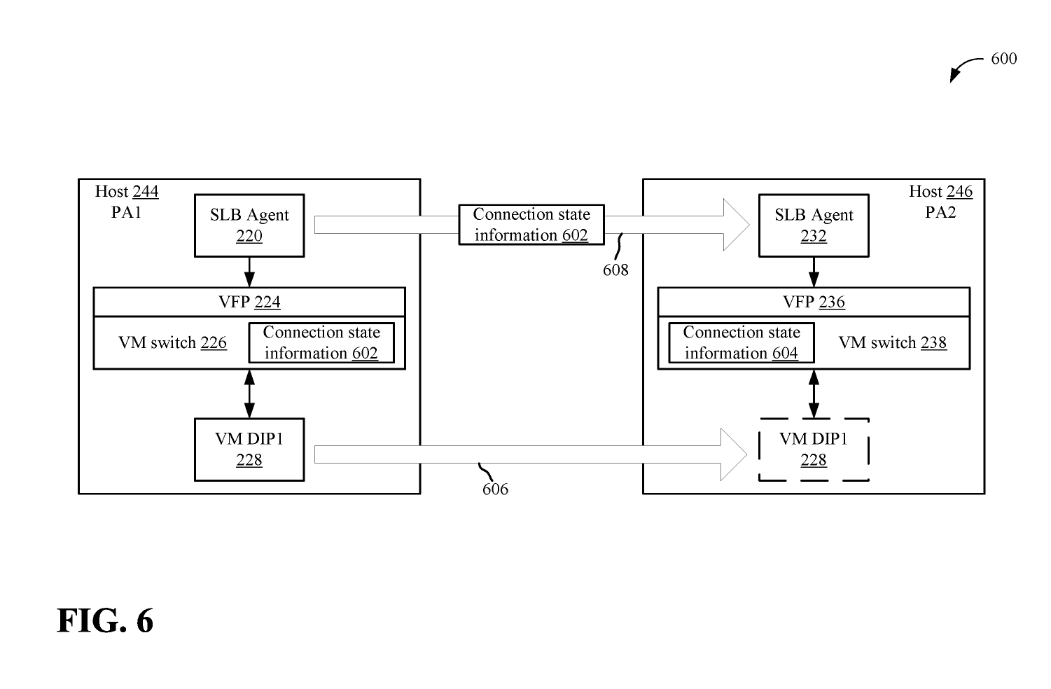

FIG. 6 depicts an example system 600 illustrating live migration of a virtual machine from a source host to a destination host. In the example illustrated, VM 228, which is associated with DIP1, is live migrated at operation 606 from host 244 having PA1, to host 246 having PA2. VM 228 may be live migrated for any of a number of reasons, such as maintenance of a host 244, and so on. VM 228 may have a number of communication links established with different VMs, one or more load balancers, MUXes, and so on. The connection rules, transformations, and/or state associated with these links may be stored as connection state information 602. As illustrated, connection state information 602 is associated with VM switch 226. It should be appreciated that any of the SLB agent 220, the VFP 224, and/or the VM switch 226 may store or maintain part or all of connection state information 602.

Upon selection of a destination host to which to live migrate a VM, such as VM 228 to host 246, or anytime thereafter, connection state information 602 may be transferred to the destination host 246, at operation 608. In some cases, operation 608 may include transferring the connection state information 602 from SLB agent 220 of host 244 to the SLB agent 232 of host 246, for example, via known communication channels within the datacenter and between hosts 244 and 246. Upon receiving the connection state information 602, the SLB agent 232 of host 246 may program or otherwise transfer the connection state information 602 to the VFP 236 and/or VM switch 238. In some aspects, transferring the connection state information 602 to the VFP 236 and/or VM switch 238 may include serializing the connection state information as part of a VM state, such as a VM save state. When the VM 228 is live migrating, the connection state information 602 may be serialized at the source host 244. Upon transfer to the destination host 246, the saved connection state information 602 may be de-serialized and applied to the port created for the VM 228 at the destination host 246. In some cases, the migration and restoration of connection state information 602 may happen as part of the regular live migration process itself.

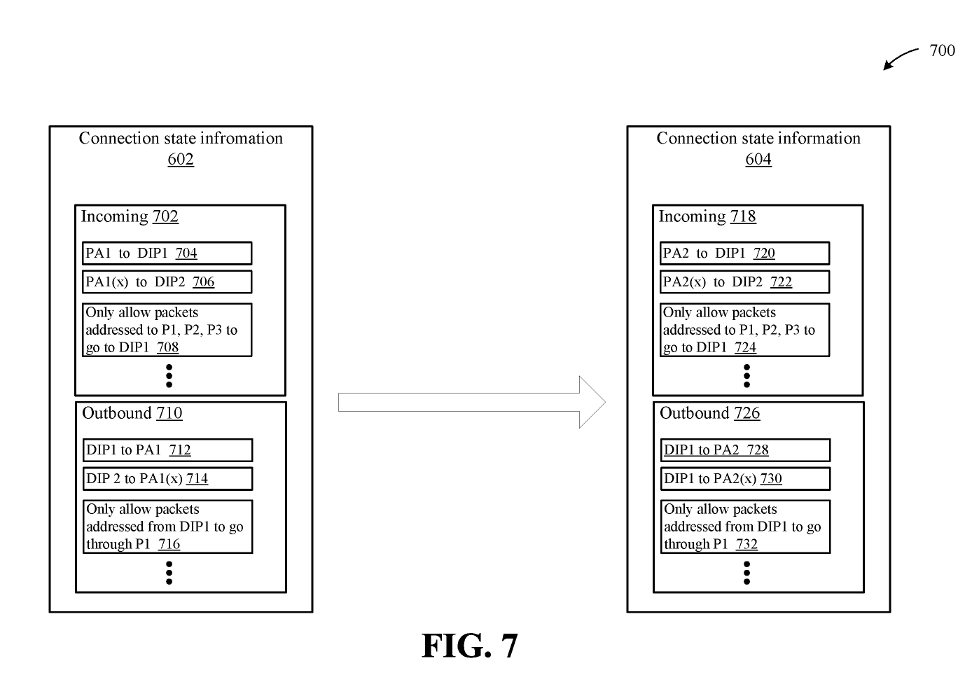

Upon obtaining the connection state information 602, any agent or component acting on behalf of the SDN controller, such as the SLB agent 232, the VFP 236, or the VM switch 238 itself, or a combination thereof, may modify the connection state information 602 to apply different host 246 specific rules, and/or update any information in connection state information 602 that pertains specifically to host 244, to host 246. An example process for updating the connection information 602 to connection information 604 will be described in greater detail below in reference to FIG. 7. In some aspects, one or more components or agents of the host 244, such as the SLB agent 220, the VFP 224, or the VM switch 226 itself, or a combination thereof, may perform one or more operations to modify the connection state information 602, based on the destination host 246, prior to sending the connection state information 602 to the destination host 246.

An example of state information that may be included in connection information 602 and 604 includes the provider or physical address (PA) of a host, such as PA1 of host 244 and PA2 of host 246. These provider addresses need to be updated to the provider address in use at the destination host/virtual switch, in order to maintain the previously established communication link or channel with the VM 228. In many instances, SDN controlled switches, such as switches 226 and 238, perform transformations necessary for a packet received in the underlay (e.g. physical address space, non-virtualized) to be fit for delivery into the overlay (e.g., virtualized space, such as DIP addresses). This is generally referred to as NAT'ing. The addresses in the overlay network may lie in the tenant virtualized address space and bear no relation to actual physical addresses in use in the datacenter (underlay network).

Transformations that are performed by these SDN switches 226 and 238 are typically expressed in the form of rules. A typical rule may include:
If a packet is addressed to the address of the underlay node (PA—Physical address), then transform it to the address in use in the overlay endpoint (CA—customer address or DIP).
   This rule may be represented in short form as:
PA->CA.

A combination of rules must be processed in a certain order on an SDN switch 226, 238, or switch port, in order to perform transformation of packets coming to/from the underlay network and also more generally to express policies of the tenant administrator. Such policies may include: only allowing packets addressed to ports P1, P2, P3 to be delivered to a certain virtualized network endpoint, or DIP.

Rules, however, are expensive to evaluate, and therefore, it is not efficient to evaluate them for every incoming packet. Typically, rules are evaluated for the first few packets and subsequent packets in a flow or over a communication link undergo the same transformation as the previous packets. As a result, instead of evaluating all the rules that can apply for each packet across the same communication link, it is more efficient to persist what transformations fields in the packet received from the underlay had to undergo in order to be delivered to the tenant virtualized endpoint or DIP. This set of transformations and associated timer states may be referred to as flow state associated with a flow, or more generally included in the term connection state information. Some layer 4 protocols (e.g., of the OSI model) are stateful, for example, including TCP protocols. A TCP connection typically has some state information associated with it. The state information may include: 1) to what extent a three-way hand shake is complete, 2) if the handshake is done and whether the connection is being used for data transfer, 3) if the connection is being torn down, and so on. In some examples of state information, timers may be associated with some of these states (e.g., a connection can stay half open for only x seconds). In some cases, VFP 224 or 236 may create state corresponding to each flow, such that the VFP 224 or 236 may store the transformations needed for a packet in the flow or configured communication link. This information is associated with a flow. Without periodically deleting some of the state information (e.g., pruning), unnecessary memory may be used at the VFP ports. As a result, that VFP 224 or 236 may prune old or not-in-use state information, periodically. In order to track which state is stale or not used, the VFP 224, 236 may associate a time to live (TTL) field with each state. This TTL field may be incremented every time a packet for the corresponding flow is processed by VFP 224, 236. In absence of new packets, the TTL field may be decremented by VFP 224, 236. When the field reaches 0, the state may be freed or deleted.

When a virtualized tenant endpoint (VM 228 DIP1) live migrates from a source host 244 to a destination host 246, all rules and flow state 602 associated with the SDN switch port 226 of the migrating endpoint may be replicated from the source host 244 to the destination host 246. As a result, the SDN switch 238 at the destination host 246, corresponding to the migrating endpoint, has all the ongoing flow state and applicable rules corresponding to the migrating endpoint, as represented by connection state information 604.

In one example, when the tenant workload is live migrated to a different destination host, all rules that involve the transformation of PA->CA need to change. This is due to the fact that the physical address (PA) changes from the source host 244 of the migrating tenant endpoint to the address of the destination host 246, i.e., PA1 becomes PA2.

Flow state transformation involving PA1->CA also need to be updated because the packets delivered to the SDN switch port 238 on the destination host 246 will be addressed to PA2. Both for performance reasons and also the infeasibility of doing so for stateful protocols, it is more efficient to update any transformations that refer to PA1 in the migrated flow to PA2. As soon as live migration completes for a virtualized tenant endpoint 228, a one-time update of the flow state (e.g., updating connections rules 602 to connection state information 604) may be performed. This may include changing all transformations involving PA1 to PA2. Performing this operation has two primary advantages:
1. It is feasible to continue delivering packets within a stateful flow even after live migration.
2. Rules need not be re-evaluated for any existing flows that have been live migrated. For both stateful and stateless protocols, the performance benefits of using flow state even after live migration can be maintained.

In some cases, the TTL field for the flow explained in above may also be carried over to the new host. However, the tick count or value of the TTL field on the new host will be different from the old host. As a result, the expiry tick count on the flows that are carried over may need to be updated. Accordingly, in some examples, PA may be updated, and in other examples, both PA and the TTL value may be updated to maintain flows through live migration.

FIG. 7 depicts an example diagram 700 of a transformation of connection state information from a source host to a destination host selected for live migration of a virtual machine. In some aspects, the process of modifying connection state information 602 to connection state information 604 may be performed by any one of the source host SLB agent 220, the source VFP 24, the source VM switch 226, or the destination SLB agent 232, the destination VFP 236, or the destination VM switch 238. In some aspects, whether one or more components of the source host 244 or the destination host 246 perform the modification may be determined based on any of a number of factors, such as host 244, 246 workloads, available processing or memory resources of each of the hosts 244, 246, whether the source host 244 is going to be taken offline immediately, the number/complexity of how many modifications are required to generate connection state information 604, and so on.

In the example illustrated, connection state information 602 may be broken up into incoming and outbound connection state information, 702 and 710, respectively. These rules may include layer mapping rules between the underlay or physical layer (e.g., PAs) and the virtualized or tenant layer (e.g., DIPs) endpoints. For example, PA1 may be mapped to DIP1 in entry 704, PA1 modified (e.g., indicating some other header or destination information) may be mapped to DIP2 at entry 706, etc. In some cases, inbound or outbound rules may include tenant specific rules, such as exclusion of or limits on ports for certain communications (e.g., entry 708 indicating that only packets addressed to specific ports may be routed to DIP1).

When connections rules 602 are transferred to another host device, such as host 246, the rules may be modified to replace any instance of a PA of the source host, e.g., PA1 of source host 244, to PA2 of destination host 246. This is illustrated by inbound entries 720 and 722, which have PA2 in place of PA1. Diagram 700 also illustrates outbound entries 726 modified from outbound entries 710, in a similar manner. In some examples, rules imposed by the source host 244 may not be maintained at the destination host 246, such as rules created to manage specific needs or resources associated with host 244, rules created to ensure rules of other tenant VMs are followed, and the like. Some examples of rules that can change with different hosts include: 1) ACLs to prevent tenant VMs from directly accessing some fabric resources of the datacenter (ACLs may vary slightly from host to host dependent on what datacenter (fabric) networks are incident on that host), and 2) QoS related state may vary from host to host.

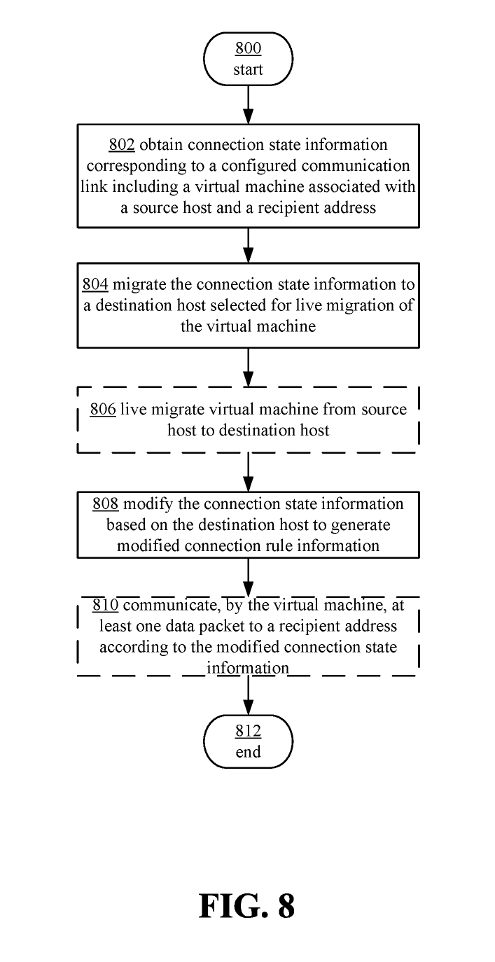

FIG. 8 illustrates an example process 800 for migrating and modifying connection rule information for a live migrated virtual machine. Process 800 may be performed, at least in part by, SLB agents 220, 232, VM switches 226, 238 and/or VFP 224, 236, and/or MUXes 214, 216, 218, and/or VMs 228, 230, 240, 242.

As illustrated, and used in this disclosure, a dotted line may indicate that an operation or component is optional, such that the described techniques may implemented without the indicated operations or components.

As illustrated, process 800 may begin at operation 802, in which connection rule information corresponding to a configured communication link including a virtual machine associated with a source host, may be obtained. In one example, operation 802 may be performed by SLB agent 220 of source host 244, for example, by querying VFP 224 and/or VM switch 226. The connection state information, which may include state information, layer transformations, or other rules, as described above, may be an example of connection state information 602.

Next, at operation 804, the connection rule information may be transferred or communicated to a destination host selected for live migration of the virtual machine. Operation 804 may be an example of operation 608 described above, with connection state information 602 being transferred to destination host 246. Operation 804 may be performed by host 244, SLB agent 220, VFP 224, or VM switch 226, or a combination thereof.

Next, at operation 806, which may be optional, the VM may be live migrated from the source host to a destination host. In some cases, operation 806 may take place at any time before operation 810 in process 800.

Next, at operation 808, the connection rule information may be modified based on the destination host, to generate modified connection rule information. In some cases, operation 808 may performed by the destination host, such as host 246, or a component thereof, such as SLB agent 232, VFP 26, or VM switch 238, or a combination thereof. In other cases, operation 808 may be performed by the source host 244, or a component there of, such as SLB agent 220, VFP 224, or VM switch 226, or a combination thereof, prior to actually transferring the connection state information or information to the destination host 246 (e.g., operation 808 may be performed before operation 804).

The virtual machine, after live migration to the destination host, using the modified connection rule information, may maintain the configured communication link with a recipient address, device, etc. In some aspects, the recipient address may include another VM, or a load balancer or MUX (which may be load balancing a connection received from an internet endpoint outside of the data center) In some cases, VMs will also continue to maintain VM initiated outbound connections (to other datacenter VIPs/Internet endpoints) after live migration, such that outbound state (SNAT) information (connection state information) may be modified also as part of the live migration process, in similar ways as described above for inbound connection state information.

In some aspects of process 800, the virtual machine, after the live migration is complete, may communicate at least one data packet to the recipient device according to the modified connection rule information, at operation 810. As described above, process 800 may enable a live migrated VM to maintain communication links that were established prior to the live migration, that have specific rules or are associated with one or more states.

In some instances, the connection rule information may include TCP layer transformation rules between a virtualized address associated with the virtual machine and a provider or physical address associated with the source host. For example, the VM may be associated with a virtualized datacenter internet protocol (DIP) address, the source host may be associated with a first provider address, and the destination host may be associated with a second provider address, In this example, the connection rule information may include one or more associations between the virtualized DIP address and the provider addresses. Also in this example, modifying the connection rule information may include updating the association between the virtualized DIP address and the first provider address to a second association between the virtualized DIP address and the second provider address. An example of this transformation is described above in reference to FIG. 7.

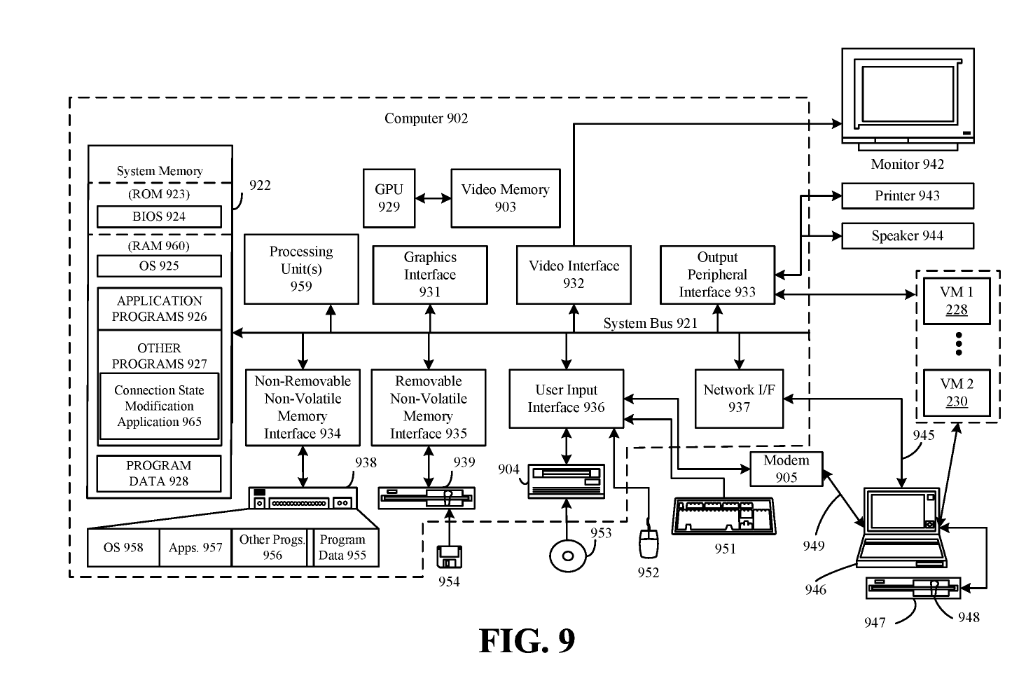

The techniques described above may be implemented on one or more computing devices or environments, as described below. FIG. 9 depicts an example general purpose computing environment, for example, that may embody one or more aspects of load balancer 112, SLBM 208, network controller 202, SLB agent 220, 232, NC agent 234, VM switch 226, 238, VFP 224, 236, MUX 214, 216, 218, or VM 228, 230, 240, 242, in which some of the techniques described herein may be embodied. The computing system environment 902 is only one example of a suitable computing environment and is not intended to suggest any limitation as to the scope of use or functionality of the presently disclosed subject matter. Neither should the computing environment 902 be interpreted as having any dependency or requirement relating to any one or combination of components illustrated in the example operating environment 902. In some embodiments the various depicted computing elements may include circuitry configured to instantiate specific aspects of the present disclosure. For example, the term circuitry used in the disclosure can include specialized hardware components configured to perform function(s) by firmware or switches. In other example embodiments, the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

Computer 902, which may include any of a mobile device or smart phone, tablet, laptop, desktop computer, or collection of networked devices, cloud computing resources, etc., typically includes a variety of computer-readable media. Computer-readable media can be any available media that can be accessed by computer 902 and includes both volatile and nonvolatile media, removable and non-removable media. The system memory 922 includes computer-readable storage media in the form of volatile and/or nonvolatile memory such as read only memory (ROM) 923 and random access memory (RAM) 960. A basic input/output system 924 (BIOS), containing the basic routines that help to transfer information between elements within computer 902, such as during start-up, is typically stored in ROM 923. RAM 960 typically contains data and/or program modules that are immediately accessible to and/or presently being operated on by processing unit 959. By way of example, and not limitation, FIG. 9 illustrates operating system 925, application programs 926, other program modules 927 including a connection state modification application 965, and program data 928.

The computer 902 may also include other removable/non-removable, volatile/nonvolatile computer storage media. By way of example only, FIG. 9 illustrates a hard disk drive 938 that reads from or writes to non-removable, nonvolatile magnetic media, a magnetic disk drive 939 that reads from or writes to a removable, nonvolatile magnetic disk 954, and an optical disk drive 904 that reads from or writes to a removable, nonvolatile optical disk 953 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 938 is typically connected to the system bus 921 through a non-removable memory interface such as interface 934, and magnetic disk drive 939 and optical disk drive 904 are typically connected to the system bus 921 by a removable memory interface, such as interface 935 or 936.

The drives and their associated computer storage media discussed above and illustrated in FIG. 9, provide storage of computer-readable instructions, data structures, program modules and other data for the computer 902. In FIG. 9, for example, hard disk drive 938 is illustrated as storing operating system 958, application programs 957, other program modules 956, and program data 955. Note that these components can either be the same as or different from operating system 925, application programs 926, other program modules 927, and program data 928. Operating system 958, application programs 957, other program modules 956, and program data 955 are given different numbers here to illustrate that, at a minimum, they are different copies. A user may enter commands and information into the computer 902 through input devices such as a keyboard 951 and pointing device 952, commonly referred to as a mouse, trackball or touch pad. Other input devices (not shown) may include a microphone, joystick, game pad, satellite dish, scanner, retinal scanner, or the like. These and other input devices are often connected to the processing unit 959 through a user input interface 936 that is coupled to the system bus 921, but may be connected by other interface and bus structures, such as a parallel port, game port or a universal serial bus (USB). A monitor 942 or other type of display device is also connected to the system bus 921 via an interface, such as a video interface 932. In addition to the monitor, computers may also include other peripheral output devices such as speakers 944 and printer 943, which may be connected through an output peripheral interface 933.

The computer 902 may operate in a networked environment using logical connections to one or more remote computers, such as a remote computer 946. The remote computer 946 may be a personal computer, a server, a router, a network PC, a peer device or other common network node, and typically includes many or all of the elements described above relative to the computer 902, although only a memory storage device 947 has been illustrated in FIG. 9. The logical connections depicted in FIG. 9 include a local area network (LAN) 945 and a wide area network (WAN) 949, but may also include other networks. Such networking environments are commonplace in offices, enterprise-wide computer networks, intranets, the Internet, and cloud computing resources.

When used in a LAN networking environment, the computer 902 is connected to the LAN 945 through a network interface or adapter 937. When used in a WAN networking environment, the computer 902 typically includes a modem 905 or other means for establishing communications over the WAN 949, such as the Internet. The modem 905, which may be internal or external, may be connected to the system bus 921 via the user input interface 936, or other appropriate mechanism. In a networked environment, program modules depicted relative to the computer 902, or portions thereof, may be stored in the remote memory storage device. By way of example, and not limitation, FIG. 9 illustrates remote application programs 948 as residing on memory device 947. It will be appreciated that the network connections shown are example and other means of establishing a communications link between the computers may be used.

In some aspects, other programs 927 may include a connection state modification application or subroutine 965 that includes the functionality as described above. In some cases, connection state modification application 965, may execute some or all operations of processes 608, 700, and/or 800. In some aspects, computing device 902 may also communicate with one or more VMs, such as VM 228, 230, etc.

Each of the processes, methods and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage. The various features and processes described above may be used independently of one another, or may be combined in various ways. All possible combinations and subcombinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from or rearranged compared to the disclosed example embodiments.

It will also be appreciated that various items are illustrated as being stored in memory or on storage while being used, and that these items or portions thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network or a portable media article to be read by an appropriate drive or via an appropriate connection. For purposes of this specification and the claims, the phrase “computer-readable storage medium” and variations thereof, does not include waves, signals, and/or other transitory and/or intangible communication media. The systems, modules and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present disclosure may be practiced with other computer system configurations.

Conditional language used herein, such as, among others, “can,” “could,” “might,” “may,” “e.g.” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only and are not intended to limit the scope of the disclosure. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of certain of the disclosure.

What is claimed is:

1. A data center, the data center comprising:
a source host device and a destination host device;
at least one virtual machine, wherein the at least one virtual machine is provided by the source host device, wherein the source host device is configured to:
obtain connection state information corresponding to a configured communication link of the at least one virtual machine; and
communicate the connection state information to the destination host device, wherein the destination host device is selected for live migration of the virtual machine;
and wherein at least one of the source host device or the destination host device is configured to:
modify the connection state information based on the destination host device to generate modified connection state information, wherein the virtual machine, after live migration to the destination host, is configured to maintain the configured communication link using the modified connection state information.

2. The data center of claim 1, wherein the configured communication link further comprises a recipient address in communication with the at least one virtual machine, and wherein the at least one virtual machine is configured to:
communicate at least one data packet to the recipient device according to the modified connection state information.

3. The data center of claim 1, wherein the at least one virtual machine is associated with a virtualized datacenter internet protocol (DIP) address, the source host device is associated with a first provider address, and the destination host device is associated with a second provider address, wherein the connection state information comprises an association between the virtualized DIP address and the first provider address, and wherein modifying the connection state information further comprises:
updating the association between the virtualized DIP address and the first provider address to a second association between the virtualized DIP address and the second provider address comprising, wherein the modified connection state information comprises the second association.

4. The data center of claim 1, wherein the connection state information and the modified connection state information each comprise TCP layer transformation rules between a virtualized address associated with the at least one virtual machine and a provider address associated with the source host device or the destination host device.

5. The data center of claim 1, wherein the source host device comprises a first switch, and wherein communicating the connection state information to the destination host device selected for live migration of the at least one virtual machine further comprises:
associating the connection state information with a second switch associated with the destination host device.

6. A method for facilitating live migration of a virtual machine from a source host to a destination host, the method comprising:
obtaining connection state information corresponding to a configured communication link, wherein the configured communication link comprises a virtual machine associated with a source host;
migrating the connection state information to a destination host selected for live migration of the virtual machine; and
modifying the connection state information based on the destination host to generate modified connection state information, wherein the virtual machine, after live migration to the destination host, is configured to maintain the configured communication link using the modified connection state information.

7. The method of claim 6, wherein the configured communication link further comprises a recipient address in communication with the virtual machine, and wherein the method further comprising:
communicating, by the virtual machine, at least one data packet to the recipient device according to the modified connection state information.

8. The method of claim 6, wherein the connection state information comprises state information.

9. The method of claim 6, wherein the virtual machine is associated with a virtualized datacenter internet protocol (DIP) address, the source is associated with a first provider address, and the destination host is associated with a second provider address, and wherein the connection state information comprises an association between the virtualized DIP address and the first provider address.

10. The method of claim 9, wherein modifying the connection state information comprises: updating the association between the virtualized DIP address and the first provider address to a second association between the virtualized DIP address and the second provider address, wherein the modified connection state information comprises the second association.

11. The method of claim 6, wherein the connection state information and the modified connection state information each comprise TCP layer transformation rules between a virtualized address associated with the virtual machine and provider address associated with the source host or the destination host.

12. The method of claim 6, wherein a first switch is associated with the source host, and wherein migrating the connection state information to the destination host selected for live migration of the virtual machine further comprises:
associating the connection state information with a second switch associated with the destination host.

13. The method of claim 12, wherein at least one of the first switch or the second switch comprise a software defined networking switch.

14. The method of claim 6, wherein the configured communication link further comprises a recipient address in communication with the virtual machine, and wherein the recipient address comprises one of a second virtual machine or a load balancer.

15. A computing system for facilitating live migration of a virtual machine from a source host to a destination host, comprising:
at least one computing device configured at least to:
obtain connection state information corresponding to a configured communication link, wherein the configured communication link comprises a virtual machine associated with a source host;
migrate the connection state information to a destination host selected for live migration of the virtual machine; and
modify the connection state information based on the destination host to generate modified connection state information, wherein the virtual machine, after live migration to the destination host, is configured to maintain the configured communication link using the modified connection state information.

16. The computing system of claim 15, wherein the virtual machine is associated with a virtualized datacenter internet protocol (DIP) address, the source is associated with a first provider address, and the destination host is associated with a second provider address, and wherein the connection state information comprises an association between the virtualized DIP address and the first provider address.

17. The computing system of claim 16, herein the at least one computing device is further configured at least to:
update the association between the virtualized DIP address and the first provider address to a second association between the virtualized DIP address and the second provider address, wherein the modified connection state information comprises the second association.

18. The computing system of claim 15, wherein the connection state information and the modified connection state information each comprise TCP layer transformation rules between a virtualized address associated with the virtual machine and provider address associated with the source host or the destination host.

19. The computing system of claim 15, wherein a first switch is associated with the source host, and wherein migrating the connection state information to the destination host selected for live migration of the virtual machine further comprises:
associating the connection state information with a second switch associated with the destination host.

20. The computing system of claim 19, wherein at least one of the first switch or the second switch comprise a software defined networking switch.
